(19) United States
(12) Patent Application Publication
(10) Pub. No.: US 2024/0425286 A1
(43) Pub. Date: Dec. 26, 2024

(54) PULLING ASSEMBLY AND AUTOMATED STORAGE SYSTEM COMPRISING SUCH AN ASSEMBLY

(71) Applicant: FIVES XCELLA, LARMOR-PLAGE (FR)

(72) Inventors: Eric COSTANTINI, LORIENT (FR); Oussama CHERIF IDRISSI EL GANOUNI, LORIENT (FR)

(21) Appl. No.: 18/574,895

(22) PCT Filed: Jun. 28, 2022
(86) PCT No.: PCT/EP2022/067679

§ 371 Date: Dec. 28, 2023

(30) Foreign Application Priority Data
Jun. 28, 2021 (FR) 2106944

(51) Int. Cl. B65G 15/36; B65G 1/04; B65G 15/44

(52) U.S. Cl. CPC B65G 15/36; B65G 1/0492; B65G 15/44

(57) ABSTRACT

A load lifting system suitable for an automated article storage system, the load lifting system including a pull assembly including a belt having a flexible body and a plurality of pull cables embedded in the flexible body, and at least one pull cleat configured to carry a hooking device intended to be attached to the at least one pull cleat, wherein the at least one pull cleat has a direct mechanical connection with all or part of the plurality of pull cables.

### TECHNICAL FIELD OF THE INVENTION

The invention is directed to a pull assembly that can be used to pull a load. One of the possible applications of such an assembly is in a load lifting system in the field of intralogistics. More particularly, one application relates to a lifting system for an automated article storage system.

### STATE OF THE ART

In such an automated article storage system, pull means are used to raise or lower loads in a rack, for example to pass a load from one storage level to another. Known pull devices include cables, chains and belts. Belts have the advantage of being flexible, requiring little maintenance and being quiet.

A belt generally consists of:
a flexible body, for example of elastomer, polyurethane or thermoplastic, and
a set of pull cables embedded in the flexible body, said cords may be made of stainless steel, fibreglass, composite, etc.

Some applications may also require hooking means to be attached to the body of the belt in order to hook the load to be lifted, which may be a carriage automatically guided in order to pass it from a load entry level to a storage level, for example. Among the existing configurations of such hooking means, latches arranged to be attached to metal inserts embedded in the flexible material or passing through it from one side to the other are known. Each latch is attached by one or more screws to the metal inserts.

One drawback of this configuration is that the material of the flexible body is loaded during a pull action and, because of the presence of the inserts, this material is embrittled, thus limiting the weight of the load that can be mounted.

Another drawback lies in the fact that the passage of the inserts and/or attaching screws can cut some pull cables, which can further embrittle the belt.

The object of the present invention is to provide a pull assembly for solving the problems described above.

### SUMMARY OF THE INVENTION

To this end, the invention relates to a pull assembly comprising:
a belt having a flexible body and a plurality of pull cables embedded in the body,
at least one pull cleat, configured to carry a hooking device intended to be attached to said cleat,
wherein the cleat has a direct mechanical connection with all or part of the plurality of pull cables.

By direct mechanical connection, it is meant that no other element is used to make the mechanical connection between the cleat and the pull cables, for example no sewing or other accessory means are used to attach the cleat to the cables.

A pull cable may comprise a single core (for example metal) or a core and sheath (for example elastomeric material), in which case the direct mechanical connection may be via the cable sheath.

By virtue of the direct connection between the cleat and the pull cables, forces generated when a load is pulled are supported by the pull cables. As a result, the material of the flexible body is not loaded and is therefore not embrittled. It therefore becomes possible to lift large loads, such as an automatically guided carriage, without risking belt breakage.

According to some exemplary embodiments, the pull cables pass through the cleat. This configuration has the advantage of being easy to manufacture. For example, the cleat can be moulded directly onto the pull cables so that the material of the cleat covers part of the pull cables.

Advantageously, a crimp can be added to reinforce hold of the cleat around the cables.

According to some exemplary embodiments, the cleat is surrounded by pull cables. This configuration makes it possible to have very large robustness because forces are supported by the pull cables.

In some exemplary embodiments, the hooking device can be a latch. The latter is attached to a cleat, for example by screwing.

In exemplary embodiments, the belt body may comprise two portions, the first portion comprising pull cables having first connection rings, the second portion comprising pull cables having second connection rings, configured to fit to said first connection rings, the cleat forming a connection axis between the two portions passing through the first and second rings. This configuration offers two advantages: ease of manufacture and robustness. Indeed, the portions of the belts are manufactured separately and then assembled using a cleat, also manufactured separately, as an assembly means. In addition, the fact that the pull cables surround the cleat via the assembly rings increases robustness of the pull assembly.

According to exemplary embodiments, the cleat may comprise a first end and a second end, each projecting from an opposite side of the belt body, the hooking device is in the form of a clip configured to be attached to said two ends of the cleat.

This attachment is simple to make and robust, as no holes need to be drilled in the cleat for screws, and attaching at the projecting ends gives added robustness.

In exemplary embodiments, the belt body may comprise a plurality of portions configured to be attached together to form the belt, at least one portion comprises a cleat.

The invention also relates to a load lifting system comprising a pull assembly according to one of the alternatives previously described.

The invention also relates to an automated article storage system comprising an lifting system as described above and an automatically guided carriage comprising a hooking means configured to cooperate with a hooking device attached to a cleat of a pull assembly as described above.

Advantageously the automated article storage system may comprise a rack having a plurality of article storage levels, wherein said lifting system connects said storage levels and is able to allow passage of an automatically guided carriage from one storage level to another.

### BRIEF DESCRIPTION OF THE FIGURES

Further features and advantages of the invention will become apparent from the description below in connection with the appended drawings, given by way of non-limiting examples, in which:

FIG. 1 represents a first example of a pull assembly according to the invention;

FIGS. 2 and 3 show a second example of a pull assembly according to the invention;

FIG. 4 shows a third example of a pull assembly according to the invention;

FIG. 5 is a cross-sectional view of a pull assembly in accordance with that of FIG. 4, further comprising a clip;

FIG. 6 shows a fourth example of a pull assembly according to the invention;

FIG. 7 shows an automated storage system according to the invention.

In the remainder of the description, elements having an identical structure or similar functions may be designated by the same references.

### DETAILED DESCRIPTION

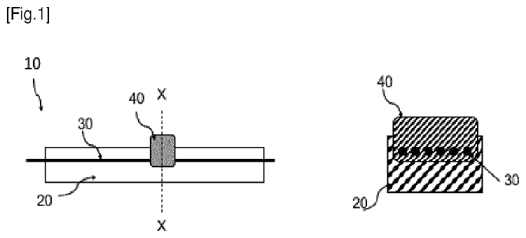

FIG. 1 schematically represents a first simplified example of a pull assembly 10 according to the invention. Pull assembly 10, as shown on the left of FIG. 1, comprises:
a belt having a flexible body 20 (for example made of elastomer) and a plurality of pull cables 30, embedded in the body 20,
at least one pull cleat 40, configured to carry a hooking device intended to be attached to said cleat (not represented in FIG. 1).

According to the invention, the cleat 40 has a direct mechanical connection with all or part of the plurality of cables 30.

In particular, in this embodiment as shown according to the cross-section view along axis X-X (right of FIG. 1), pull cables 30 pass through the cleat 40.

Such a configuration can, for example, be obtained by casting material in a gutter or linear mould.

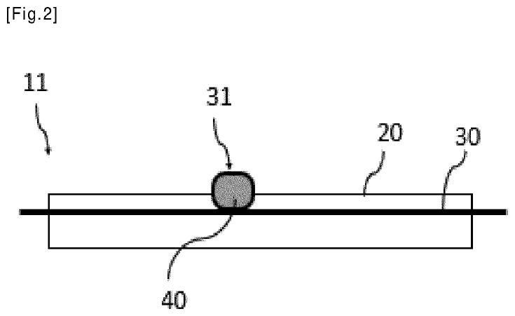

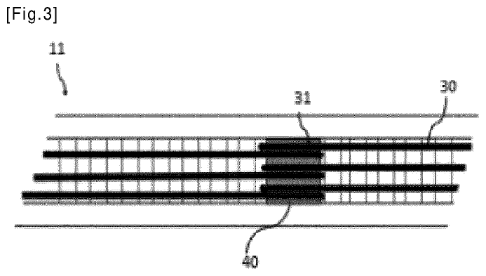

FIGS. 2 and 3 show a pull assembly 11 which differs from the pull assembly in FIG. 1 mainly in that the cleat 40 is surrounded by pull cables 30 which form loops 31 around the cleat.

The other components may be similar to those previously shown in connection with the example of FIG. 1.

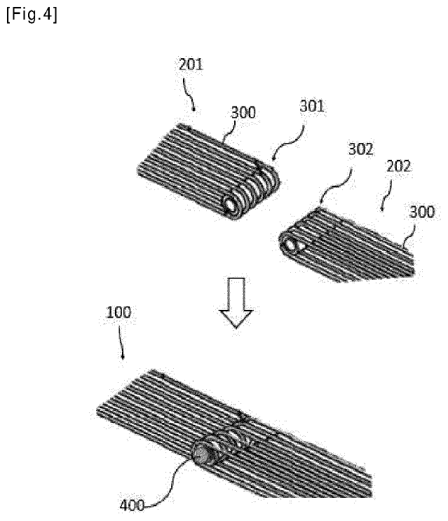

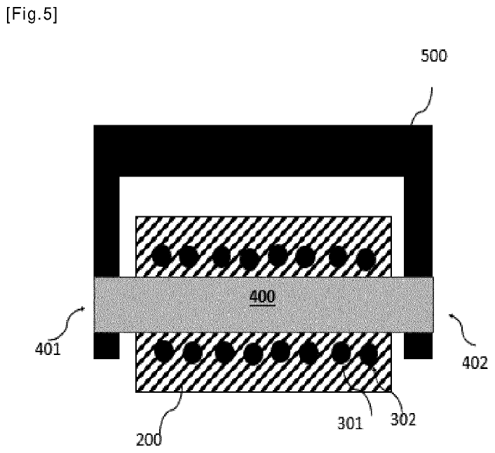

FIG. 4 shows a third exemplary embodiment wherein the pull assembly 100 comprises a flexible body which includes at least two portions 201, 202 intended to be connected together. For ease of understanding, only the pull cables 300 are shown, the material surrounding them is not visible in FIG. 4, it is however represented in FIG. 5.

The pull cables 300 of the first portion 201 comprise first connection rings 301; the pull cables 300 of the second portion 202 comprise second connection rings 302.

The connection rings are configured to fit together and a cleat 400 forms a connection axis between the two portions passing through the first 301 and second 302 rings.

As is shown in FIG. 5, the cleat 400 may comprise a first end 401 projecting from one side of the flexible body and a second end 402 projecting from the opposite side.

The hooking system may comprise a hooking device 500 in the form of a clip configured to be attached to both ends 401, 402 of the cleat 400.

Other forms of attachment device are obviously possible for the above example, but also for all the alternatives of pull assemblies described in this application.

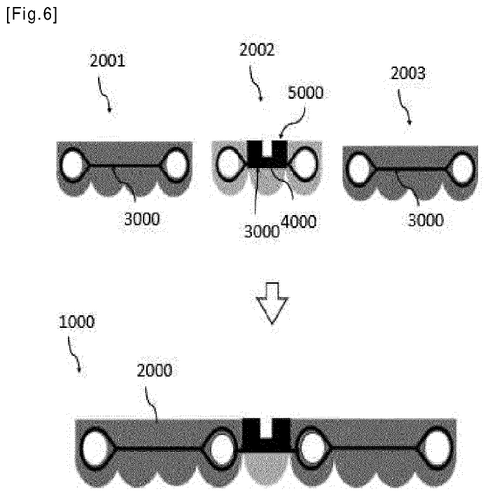

FIG. 6 shows a third exemplary embodiment wherein the pull assembly 1000 has a belt 2000 whose body comprises a plurality of portions 2001, 2002, 2003. The belt portions are configured to be attached together to form the belt. In this alternative embodiment, a portion 2002 may comprise a cleat 4000, which may have an opening able to receive a pin, as can be seen in FIG. 6. The belt can, of course, comprise a plurality of portions similar to the portion 2002.

In this case, the portions comprising a cleat are manufactured separately and added to the belt if need be. This makes it possible to obtain a modular belt. For example, if it is noticed that the portion that includes a cleat (thus which is highly loaded during a pull action) is showing signs of fatigue, it can simply be replaced. Maintenance is thus facilitated.

The pull system according to one of the combinations of characteristics described above can advantageously be used in a load lifting system.

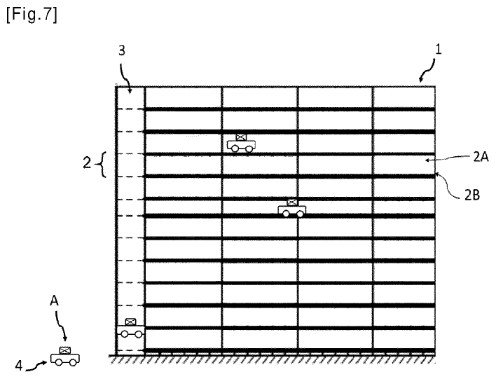

FIG. 7 shows an example of an automated article storage system comprising a lifting system as described above.

The storage system in this example comprises a stock formed by a three-dimensional rack 1 and a plurality of automatically guided carriages 4. The rack 1 comprises a plurality of storage levels 2, each storage level 2 may comprise locations for storing items, for example in the form of shelves 2A. Each storage level 2 may further comprise an aisle 2B in which a carriage 4 may circulate to deposit or pick up an item A. In exemplary embodiments not illustrated, a storage level 2 may comprise a plurality of aisles for the circulation of automatically guided carriages 4.

The rack 1 may further comprise one or more columns 3 (for example in the form of wells) connecting the plurality of storage levels 2 and allowing displacement of automatically guided carriages 4 from one level 2 to another, or between a storage level 2 and an entry/exit level. For example, the entrance/exit level may be the lowest level (at ground level), but it may also be the highest level (the roof). In examples not illustrated, the lowest level may be an entrance (or exit) and the highest level an exit (or entrance).

The lifting system as described above may be arranged in the column 3 and may comprise a plurality of pull assemblies according to the invention. Each pull assembly comprises a belt and at least one cleat, as well as one or more hooking device(s) attached to the cleat. The hooking device can have different shapes, for example the shape of a clip as shown in FIG. 5 or the shape of a latch.

To enable carriages to be lifted, each automatically guided carriage 4 comprises hooking means configured to cooperate with the hooking devices.

The column 3 further comprises motor-drive means enabling the belts to be displaced along the column, thus causing the carriages 4 to be displaced vertically from one storage level to another.

1. A load lifting system suitable for an automated article storage system, the load lifting system comprising a pull assembly comprising:
a belt having a flexible body and a plurality of pull cables embedded in the flexible body, and
at least one pull cleat configured to carry a hooking device intended to be attached to said at least one pull cleat,
wherein the at least one pull cleat has a direct mechanical connection with all or part of the plurality of pull cables.

2. The load lifting system according to claim 1, wherein pull cables pass through the at least one pull cleat.

3. The load lifting system according to claim 1, wherein the at least one pull cleat is surrounded by pull cables.

4. The load lifting system according to claim 2, wherein the hooking device is a latch.

5. The load lifting system according to claim 3, wherein the flexible body comprises two portions, a first portion of the two portions comprising pull cables having first connection rings, a second portion of the two portions comprising pull cables having second connection rings, configured to fit to said first connection rings, the at least one pull cleat forming a connection axis between the two portions passing through the first and second rings.

6. The load lifting system according to claim 5, wherein the at least one pull cleat comprises a first end and a second end, each projecting from an opposite side of the flexible body of the belt, the hooking device is in the form of a clip configured to be attached to said two ends of the at least one pull cleat.

7. The according to claim 1, wherein the flexible body of the belt comprises a plurality of portions configured to be attached together to form the belt, at least one portion comprises a cleat.

8. (canceled)

9. An automated article storage system comprising a lifting system according to claim 1 and an automatically guided carriage comprising hooking means configured to cooperate with a hooking device attached to a cleat of a pulling assembly.

10. The automated article storage system according to claim 9, comprising a rack having a plurality of levels for storing articles, wherein said lifting system connects said storage levels and is able to allow passage of an automatically guided carriage from one storage level to the other.
